(19) United States
(12) Patent Application Publication
(10) Pub. No.: US 2026/0029070 A1
(43) Pub. Date: Jan. 29, 2026

(54) FLEXIBLE CONDUCTING ELEMENT FOR TRANSPORTING HYDROGEN-CONTAINING FLUIDS

(71) Applicant: ELAFLEX HIBY GmbH & Co. KG, Hamburg (DE)

(72) Inventors: Stefan Kunter, Hamburg (DE); Carsten Tonn, Bad Segeberg (DE); Peter Fahrenbach, Hamburg (DE)

(21) Appl. No.: 19/150,022

(22) PCT Filed: Feb. 5, 2024
(86) PCT No.: PCT/EP2024/052685

§ 371 Date: Jul. 22, 2025

(30) Foreign Application Priority Data
Feb. 3, 2023 (EP) 23154821.5

(51) Int. Cl. F16L 11/08; F16L 11/12

(52) U.S. Cl. CPC F16L 11/088; F16L 11/12

(57) ABSTRACT

The subject matter of the invention is a flexible conducting element (12) for transporting a hydrogen-containing fluid, having an inner layer (14), conducting the hydrogen-containing fluid, and an outer layer (13), surrounding the inner layer (14). The inner layer (14) consists of a first material and the outer layer (13) consists of a second material. According to the invention, the conducting element has the following features:—a hydrogen permeability at a temperature of 293 K of the first material is 1.5·10⁻⁹mol/(m s MPa) or less,—the inner layer (14) and the outer layer (13) are designed in such a way that, for a predefined temperature and a predefined partial pressure difference, a hydrogen permeability rate of the inner layer (14) is lower by a factor of 2 or more than a hydrogen permeability rate of the outer layer (13), and—a Shore A hardness of the first material and a Shore A hardness of the second material are less than 90. As a result of its advantageous properties, the conducting element according to the invention can be flexibly and dependably used for transporting hydrogen.

A subject of the present invention is a flexible conduit element for transporting hydrogen-containing fluids. The conduit element comprises an inner layer which conducts the hydrogen-containing fluid and an outer layer which surrounds the inner layer, the inner layer consisting of a first material and the outer layer consisting of a second material.

Conduit elements of these kinds for transporting hydrogen-containing fluids are employed, for example, in gas supply networks, in the fueling sector, and as supply conduits within fuel cells or gas heating systems (at least partly operated with hydrogen). In these cases, the material of the inner layer may be designed in such a way as to maximize resistance toward the transported medium, while the material of the outer layer may be designed in such a way as to maximum resistance toward the prevailing environmental influences (for example, toward abrasion or other mechanical stresses, UV radiation, ozone, etc.). Under the existing usage conditions, the conduit element must be sufficiently impermeable to prevent emergence of substantial amounts of hydrogen from the conduit element and to prevent the development of explosive atmospheres outside the conduit element.

U.S. Pat. No. 6,213,155 B1 discloses a fluid-impervious composite hose having a metal foil in its wall, wherein one of a plurality of layers forming the wall of the hose is a laminated layer formed by laminating the metal foil, a reinforcing material of high stretch resistance, and a resin film.

Against this background, the object of the present invention is to provide a conduit element for transporting hydrogen-containing fluids that can be used flexibly and ensures high operating safety.

The conduit element of the invention is characterized by features as follows:
a hydrogen permeability at a temperature of 293 K of the first material is 4.0·10⁻⁹ mol/(ms MPa) or less,
the inner layer and the outer layer are designed in such a way that at specified temperature and specified partial pressure difference, a hydrogen transmission rate of the inner layer is lower by a factor of 2 or more than a hydrogen transmission rate of the outer layer,
a Shore A hardness of the first material and a Shore A hardness of the second material are less than 90.

First, some terms used within the present description are explained. The term “hydrogen-containing fluid” denotes a gaseous or liquid medium or a medium consisting, in a hybrid form, of gaseous and liquid fractions, this medium containing gaseous hydrogen. The hydrogen-containing fluid may also have other constituents. For example, the hydrogen-containing fluid may be a mixture of gaseous hydrogen with one or more gaseous hydrocarbons (e.g., natural gas) or may be a mixture of gaseous hydrogen with a liquid gas (e.g., liquefied petroleum gas (LPG)).

The temperature-dependent hydrogen permeability (hereinafter also denoted by (T), where T represents the temperature) of a material denotes the particulate amount of hydrogen (hereinafter also represented by N_{H}) which passes per unit time (hereinafter also represented by t), unit area (hereinafter also represented by A) and partial pressure difference (hereinafter also represented by (p₁-p₂), where p₁ and p₂ represent the hydrogen partial pressures prevailing on either side of the layer of material in question) through a nonporous barrier of defined layer thickness (also denoted by L below) which is formed of the material. For the hydrogen permeability, therefore, the relation is as follows:

$$ϕ ( T ) = ( {N}_{H} \cdot L ) / ( t \cdot A \cdot ( {p}_{1} - {p}_{2} ) )$$

The hydrogen permeability may be determined according to DIN 53536 and reported, for example, using the unit mol/(ms MPa) (mole per (meter times second times megapascal)).

The hydrogen transmission rate of a layer denotes the mass of hydrogen in the hydrogen-containing fluid that passes per unit time under specified conditions through the layer, particularly with specifying the parameters of hydrogen partial pressure difference, temperature, area, and layer thickness of the barrier formed by the layer. At specified temperature and hydrogen partial pressure difference, the hydrogen transmission rate of a nonporous layer is given by the hydrogen permeability of the material, the particle weight, the area of the layer that is available for passage, and the layer thickness. If the layer is porous and/or has passage ducts, hydrogen may additionally pass through these ducts. Such ducts may be made in the layer mechanically, by means of so-called “pricking”, for example.

The Shore A hardness may be determined, for example, according to DIN ISO 7619-1.

The conduit element may be rated for a maximum pressure of between 6 bar and 100 bar. Moreover, the conduit element may be rated for a temperature range between −50°° C. and 150° C. The inner layer may be connected to the outer layer with the aid of a tie layer. Moreover, one or more strength members may be provided between the inner layer and the outer layer.

The second material is preferably different from the first material.

The low hydrogen permeability of the first material may ensure that, in operation, only very small amounts of the hydrogen can emerge outwardly through the inner layer from the transport channel enclosed by the inner layer. It has been recognized in the context of the invention that however, this is not enough on its own to provide a safe conduit element which is stable over prolonged periods. In particular it has been recognized that a quantity of hydrogen may accumulate over prolonged periods between the inner layer and the outer layer. An associated buildup in pressure between the layers can lead to the outer layer detaching from the inner layer and hence to destruction of the conduit element. In order to prevent such an accumulation of gas in an intermediate space (for example in the region of the tie layer or in the region of the strength member), the inner layer and the outer layer are designed in such a way that the hydrogen transmission rate of the inner layer (given identical test conditions) is lower than that of the outer layer. This measure may ensure that particles of hydrogen emerging outwardly through the inner layer from the interior (within the inner layer) at a certain rate migrate further through the outer layer at a higher rate and so are delivered to the surroundings, without a quantity of gas being able to accumulate between the layers.

In one advantageous embodiment, it is provided that the ratio of the hydrogen permeability of the first material ϕ₁(T) to a layer thickness of the inner layer L₁ is lower than the ratio of a hydrogen permeability of the second material ϕ₂(T) (at the same temperature) to a layer thickness L₂ of the outer layer. In this case, therefore, ϕ₁(T)/L₁<ϕ₂(T)/L₂. Additionally, the hydrogen transmission rate of the inner layer may lower by a factor of more than or equal to 2, preferably by a factor of more than or equal to 5, more preferably by a factor of more than or equal to 10 and particularly preferably by a factor of more than or equal to 15 than the hydrogen transmission rate of the outer layer. It is appreciated that the ratios specified above are based on test conditions which are identical for inner layer and outer layer. Through the features stated above, an accumulation of gas between the inner layer and the outer layer can be prevented in a particularly reliable way, with the low hydrogen permeability of the inner layer ensuring at the same time that in total only a small amount of hydrogen emerges from the conduit element.

A layer thickness L₁ of the inner layer may be, for example, between 0.4 and 5.0 mm, preferably between 1.0 and 3.0 mm. A layer thickness L₂ of the outer layer may be between 1.0 and 5.0 mm, preferably between 1.5 and 5.0 mm.

In the prior art, it was customary to use a material having a high layer thickness for the inner layer and to produce a mechanically stable and strong connection between inner and outer layers to prevent the outer layer detaching from the inner layer. This frequently resulted in conduit elements of low flexibility or bendability. Because regular bending of the conduit element may result in increased friction between the inner layer and the outer layer, promoting the process of detachment of the outer layer from the inner layer, the low bendability accordingly offered additional advantages in terms of the integrity of the connection between inner and outer layers. Conversely, in the context of the invention, in light of the difference provided by the invention in the hydrogen transmission rates of the inner layer and the outer layer and in light of the low hydrogen permeability of the first material, the problem of detachment of the outer layer from the inner layer is significantly alleviated. For this reason, with the conduit element of the invention, it is possible to use a first material of low Shore A hardness, which tends to be associated with high elasticity. Through the invention, this makes it possible for very flexible conduit elements to be produced, with the risk of detachment of the outer layer from the inner layer being kept simultaneously low. This significantly extends the scope of application of the conduit element and improves the user-friendliness. In particular, smaller bending radii can be realized. The use of the conduit element for example in the context of fueling applications is greatly facilitated.

It has been recognized, furthermore, that the conduit element can be employed in a compensator to compensate or accommodate movements, vibrations or changes in length of fixed pipelines. The low Shore A hardness of the first material allows movements and vibrations to be accommodated with particular efficiency.

The Shore A hardness of the first material may be less than 85, preferably less than 80, more preferably less than or equal to 75. The Shore A hardness of the second material may likewise be less than or equal to 85, preferably less than or equal to 80, more preferably less than or equal to 75. This further increases the flexibility. Provision may additionally be made for a Shore A hardness of the first material to be more than 30, preferably more than 50, more preferably more than 60.

The flexible conduit element may have at least one of the further features:
the first material has a hydrogen permeability at a temperature of 293 K of 2.4·10⁻⁹ mol/(ms MPa) or less, preferably 1.8·10⁻⁹ mol/(ms MPa) or less, more preferably 1.2·10⁻⁹ mol/(ms MPa) or less, more preferably 1.0·10⁻⁹ mol/(ms MPa) or less,
a hydrogen permeability at a temperature of 293 K of the first material is lower than a hydrogen permeability at a temperature of 293 K of the second material.

It may be provided that the outer layer has mechanically produced hydrogen passage ducts which are designed to increase a hydrogen transmission rate of the outer layer. The hydrogen passage ducts represent perforations in the outer layer and may be produced by so-called “pricking”, by puncturing the outer layer with dimensionally stable needles of very low diameter.

The first material is preferably an elastomer in a temperature range between −50° C. and 150° C. or it has elastomeric properties in this temperature range. The aforementioned temperature range may preferably be between −40° C. and 120°° C., more preferably between −30° C. and 100°° C., more preferably between −20° C. and 90° C. This means that under tensile or compressive load, the material undergoes rubberlike (i.e. “entropy-elastic”) deformation and, on removal of the load, substantially regains its original form. Below the glass-rubber transition temperature, the first material has thermoplastic properties. In particular, the elasticity of the material may decrease by multiple orders of magnitude at the transition. With an elastomer, there is a fixed relation between the Shore A hardness and the modulus of elasticity in compression (see, for instance, “Determining the Modulus of Elasticity in Compression of Elastomers via the Shore A Hardness”, reprint from the journal Kunststoffe 6/2006, pages 92-94, Carl Hanser Verlag, Munich, 2006). It has emerged that, especially when the first material is an elastomer, the low Shore A hardness of the invention is accompanied by a low modulus of elasticity.

In one advantageous embodiment, the first material comprises chlorosulfonated polyethylene rubber or epichlorohydrin rubber. It may be provided that the first material consists predominantly or exclusively of chlorosulfonated polyethylene rubber or epichlorohydrin rubber.

The second material is preferably an elastomer in a temperature range between −65° C. and 150° C. or it has elastomeric properties in this temperature range. In one embodiment, the second material comprises chloroprene rubber. It may be provided that the second material consists predominantly or exclusively of chloroprene rubber. The materials stated can be used to produce a conduit element which is sufficiently impermeable and at the same time has the ratio, according to the invention, of the hydrogen transmission rates, a low hardness, and a high flexibility.

In one embodiment, the flexible conduit element comprises one or more strength members arranged between the inner layer and the outer layer. Alternatively, the strength member may also be embedded in the inner layer or in the outer layer or applied on the outer layer. This design serves in particular for transporting fluids that are under high pressure, for example for transporting gases liquefied under pressure. The strength member or parts of the strength member may be formed of a metal. It is preferably provided that the strength member comprises or consists of a chromium-nickel-molybdenum steel. The carbon content of the chromium-nickel-molybdenum steel may more preferably be 0.03% by weight or less. Alternatively or additionally, the nickel content of the chromium-nickel-molybdenum steel may be 12% by weight or more. Alternatively or additionally, the chromium-nickel-molybdenum steel may be X2CrNiMo17-12-2 as per AISI 316L or X2CrNiMo18-14-3 as per AISI 316L or X6Cr·Ni·Mo·Ti17-12-2 as per AISI 316Ti. The aforesaid metallic strength members are notable for low hydrogen embrittlement.

In one embodiment, the conduit element is designed in such a way that an electrical resistance measured between the inner layer and the outer layer is less than 10° ohms, preferably less than 10⁶ ohms. The electrical resistance between the inner layer and the outer layer may be measured by electrically contacting the conduit element at a first areal element on the outer surface of the outer layer and at a second areal element, opposite the first areal element, on the inner face of the inner layer, and measuring the resistance between the areal elements. Moreover, an electrical resistance measured between the ends of the conduit element may be less than 10⁹ ohms, preferably less than 10⁶ ohms, more preferably less than 10⁵ ohms. The electrical resistance measured between the ends of the conduit element is obtained by jointly electrically contacting at each of the ends of inner and outer layer, and measuring the resistance between the two contacts. A resistivity of the conduit element may be less than 10¹⁰ ohms/m, preferably less than 10⁷ ohms/m, more preferably less than 10⁶ ohms/m. The aforementioned resistivity is obtained by electrically contacting the two layers simultaneously at two areal elements, spaced apart from one another in longitudinal direction, and determining the resistance per unit length between the two areal elements. A resistivity of the outer layer or of the inner layer of the conduit element in one embodiment is less than 10¹⁰ ohms/m (ohms per meter), preferably less than 10⁷ ohms/m, more preferably less than 10⁶ ohms/m. The aforementioned resistivity of a layer is obtained by measuring the respective layer independently of the respectively other layer (that is, without being electrically conductively connected to the respectively other layer). It has emerged that the abovementioned electrical resistances (resistivities) enable reliable diversion of electrical charges and hence are able to prevent sparking. In this case, it is preferably ensured that sufficient diversion of charge takes place in each of the two layers along the longitudinal direction and moreover also a diversion of electrical charges from one layer into the other layer is possible. The aforementioned resistances (along and between the conduit elements) may be obtained, in a manner known in principle, through the addition of conductive adjuvants (e.g., industrial carbon black) to the material of the respective layer, for example. The aforementioned resistances may be measured in particular in the manner described in DIN EN ISO 8031. By making, preferably, both the inner layer and the outer layer electrically conductive as elucidated above, the invention sets itself apart from the stipulations from DIN EN ISO 8031, whereby, in the case of multilayer hoses, either only the inner layer or only the outer layer is to be electrically conductive.

Furthermore, one subject of the invention is a compensator which comprises a flexible conduit element of the invention, a first compensator fitting connected to a first end of the flexible conduit element, and a second compensator fitting connected to a second end of the flexible conduit element. The compensator fitting preferably has an outwardly projecting flange element. The flange element may have a platelike configuration and extend outwardly from a peripheral face of the conduit element substantially perpendicularly to an axial direction of the conduit element. The flange element may have a plurality of through-holes extending in axial direction and as viewed in axial direction may have a thickness of between 0.5 cm and 5 cm, preferably between 1 and 3 cm.

The compensator fittings may each be connected to a mating component. The connection may be realized, for example, by a screw connection. In this way, the compensator may be connected in particular to fixed pipelines, and it serves to accommodate or compensate movements, changes in length, or vibrations of the fixed pipelines. It has emerged that the conduit element of the invention is particularly suited to this purpose by virtue of its low hardness.

An internal diameter of the conduit element in one embodiment may be between 20 mm and 500 mm, preferably between 25 mm and 150 mm. The internal diameter of the conduit element arises from the internal diameter of the inner layer. In the prior art, conduit elements having internal diameters in this order of magnitude were unsuitable for compensators, as at these diameters the flexibility and bendability of the conduit element are much too low.

In one embodiment, an electrical resistance measured between the compensator fittings is less than 10⁹ ohms, preferably less than 10⁶ ohms, more preferably less than 10⁵ ohms. For the compensator as well, these measures are able to ensure that electrical charges on the conduit element are diverted reliably via the conduit element and that no large static charges are developed. As a result, sparking and associated risk of explosion can be avoided.

Furthermore, a subject of the invention is a flexible hose conduit comprising a flexible conduit element of the invention and at least one, preferably two, hose fittings connected terminally to the flexible conduit element. The hose fitting can be used to connect the hose conduit to a matching junction. In one embodiment, an electrical resistance measured between the hose fittings (and arising substantially by the resistance of the conduit element) is less than 10⁹ ohms, preferably less than 10⁶ ohms, more preferably less than 10⁵ ohms. The advantages already stated above are actualized in this case as well.

An internal diameter of the conduit element may be, for example, between 8 mm and 50 mm, preferably between 13 mm and 25 mm. In the prior art, conduit elements for transporting hydrogen were extremely inflexible, especially with relatively large internal diameters.

Below, advantageous embodiments of the invention are elucidated illustratively with reference to the appended drawings, in which:

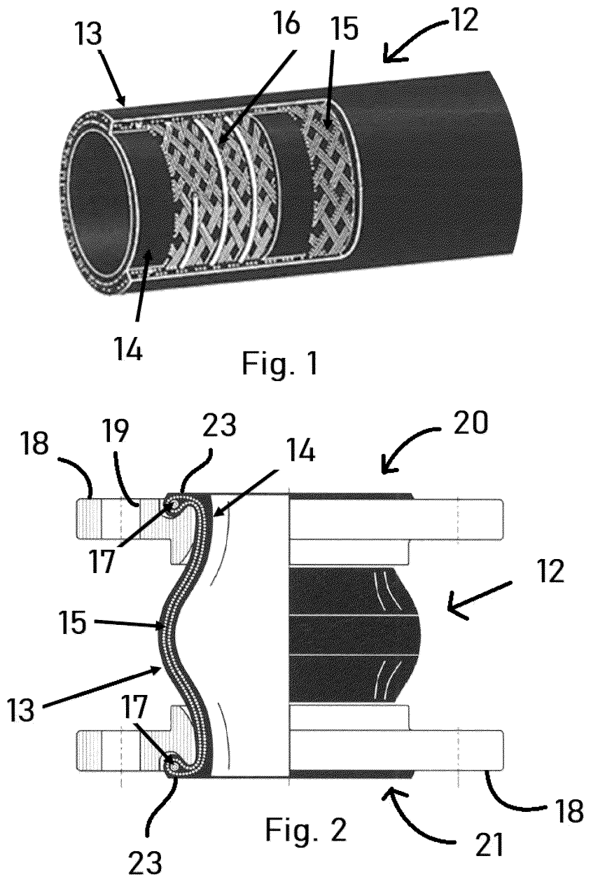

FIG. 1: shows a representation, in partial section, of one embodiment of a conduit element of the invention;

FIG. 2: shows a side view, in partial section, of a compensator of the invention;

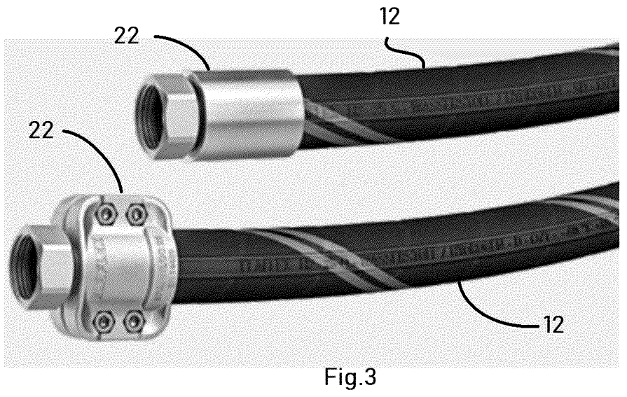

FIG. 3: shows a side view of two hose elements of the invention.

FIG. 1 shows a three-dimensional side view, in partial section, of a conduit element 12 of the invention for transporting a hydrogen-containing fluid. The conduit element 12 comprises an inner layer 14 which is of cylindrical design and serves for conducting the hydrogen-containing fluid. The inner layer 14 is produced from chlorosulfonated polyethylene rubber which has a Shore A hardness of 75 and a hydrogen permeability at a temperature of 293 K of 1.0. 10⁻⁹ mol/(ms MPa). The thickness of the inner layer is 2 mm. An internal diameter of the inner layer is 20 mm.

Located outside the inner layer 14 is a likewise cylindrical outer layer 13, which over its full periphery is in contact with the inner layer 14 and which by virtue of the production process is fusionally connected to the inner layer 14. The outer layer 13 is produced from chloroprene rubber which has a Shore A hardness of 60 and a hydrogen permeability at a temperature of 293 K of 10·10⁻⁹ mol/(ms MPa). The thickness of the outer layer 13 is likewise 2 mm. A hydrogen transmission rate of the inner layer is presently approximately 10 times lower than a hydrogen transmission rate of the outer layer. In an alternative embodiment, the hydrogen transmission rate of the outer layer may also be (additionally) increased through the introduction of hydrogen passage ducts, and so it is not absolutely necessary for the hydrogen permeabilities of the materials of the inner layer and of the outer layer to differ by a factor of 10.

During the production of the conduit element, a first strength member 15 formed by a metal braid and also a second strength member 16 formed by a metal coil are embedded between the inner layer and the outer layer. The strength members 15, 16 are formed of X2CrNiMo17-12-2. In one embodiment, it may be provided that a further strength member is provided, formed by a metal braid and arranged outside the metal coil (not shown). In this case, the metal coil is surrounded by metal braids on either side.

FIG. 2 shows a side view, in partial section, of a compensator of the invention. The compensator comprises a conduit element 12 of the invention, where the elements already stated above in connection with FIG. 1 are provided with the same reference signs in FIG. 2. Additionally, the compensator comprises compensator fittings 18 which are connected to the ends 20, 21 of the conduit element and are presently formed by flange elements outwardly projecting perpendicularly to an axial direction of the conduit element 12. The compensator fittings 18 comprise through-holes 19 which extend in axial direction and through which fastening elements may be guided in order to produce a connection to a corresponding flange element.

In contrast to the embodiment of FIG. 1, the conduit element 12 in the embodiment of FIG. 2 is not of cylindrical design, but instead bulges outward in the middle between the compensator fittings 18. This enables more effective compensation of movements and vibrations of pipe elements which are connected to the compensator by means of the compensator fittings 18.

In contrast to the conduit element of FIG. 1, an additional strength member 17 is embedded into the material of the inner layer 14 at each of the ends 20, 21 of the conduit element 12. The strength member 17 is formed of a metal wire made of X2CrNiMo18-14-3 and extends circularly along the periphery of the conduit element 12. A circular groove is made at each of the end-face ends of the compensator fittings 18, and the strength member 17 together with the respective end 20, 21 of the conduit element is set into this groove. When a connection is produced between a compensator fitting 18 and a corresponding flange element, an end face of the compensator fitting 18 is pressed against an end face of the corresponding flange element. The part of the conduit element (connecting portion 23) that is set into the groove is clamped in between the compensator fitting and the corresponding flanged element in this operation, and in that way is fixed.

FIG. 3 shows a side view of two flexible hose conduits of the invention. Each of the hose conduits comprises a conduit element 12 of the invention and also a hose fitting 22 mounted at one end of the conduit element 12.

1. A flexible conduit element (12) for transporting a hydrogen-containing fluid, having an inner layer (14) which conducts the hydrogen-containing fluid, and an outer layer (13) which surrounds the inner layer (14), the inner layer (14) consisting of a first material and the outer layer (13) consisting of a second material, characterized by the following features:
a hydrogen permeability at a temperature of 293 K of the first material is 4.0·10⁻⁹ mol/(m s MPa) or less,
the inner layer (14) and the outer layer (13) are designed in such a way that at specified temperature and specified partial pressure difference, a hydrogen transmission rate of the inner layer (14) is lower by a factor of 2 or more than a hydrogen transmission rate of the outer layer (13), and
a Shore A hardness of the first material and a Shore A hardness of the second material are less than or equal to 90.

2. The flexible conduit element (12) as claimed in claim 1, wherein the Shore A hardness of the first material and/or the Shore A hardness of the second material are less than or equal to 85.

3. The flexible conduit element (12) as claimed in claim 1, wherein the hydrogen transmission rate of the inner layer (14) is lower by a factor of 5 or more, than the hydrogen transmission rate of the outer layer (13).

4. The flexible conduit element (12) as claimed in any of claim 1, characterized by at least one of the further features:
the first material has a hydrogen permeability at a temperature of 293 K of 2.4·10⁻⁹ mol/(m s MPa) or less,
a hydrogen permeability at a temperature of 293 K of the first material is lower than a hydrogen permeability at a temperature of 293 K of the second material.

5. The flexible conduit element (12) as claimed in claim 1, wherein the outer layer (13) has mechanically produced hydrogen passage ducts which are designed to increase a hydrogen transmission rate of the outer layer (13).

6. The flexible conduit element (12) as claimed in any of claim 1, wherein a Shore A hardness of the first material is more than 50.

7. The flexible conduit element (12) as claimed in claim 1, wherein the first material has elastomeric properties in a temperature range between −50° C. and 150° C.

8. The flexible conduit element (12) as claimed in any of claim 1, wherein the first material comprises or consists of chlorosulfonated polyethylene rubber or epichlorohydrin rubber.

9. The flexible conduit element (12) as claimed in claim 1, wherein the second material has elastomeric properties in a temperature range between −50° C. and 150° C.

10. The flexible conduit element (12) as claimed in claim 1, wherein the second material comprises or consists of chloroprene rubber.

11. The flexible conduit element (12) as claimed in any of claims 1 to 10, which additionally has at least one strength member (15, 16, 17), which is arranged between the inner layer (14) and the outer layer (13) or is embedded in the inner layer (14) and/or the outer layer (13) or is applied on the outer layer.

12. The flexible conduit element (12) as claimed in claim 11, wherein the at least one strength member (15, 16, 17) is formed of a metal and comprises or consists of chromium-nickel-molybdenum steel.

13. The flexible conduit element as claimed in claim 1, which is designed in such a way that
an electrical resistance measured between the inner layer (14) and the outer layer (13) is less than 10⁹ ohms, and/or
an electrical resistance measured between the ends of the conduit element is less than 10⁹ ohms, and/or
a resistivity of the outer layer or of the inner layer of the conduit element is less than 10¹⁰ ohms/m, and/or
a resistivity of the conduit element is less than 10¹⁰ ohms/m.

14. A compensator comprising a flexible conduit element (12) as claimed in claim 1, a first compensator fitting (18) connectable or connected to a first end (20) of the flexible conduit element (12), and a second compensator fitting (18) connectable or connected to a second end (21) of the flexible conduit element (12), wherein the flexible conduit element has a terminal connecting portion (23) which, when a connection is produced between one of the compensator fittings and a corresponding junction element, is clamped in between the compensator fitting and the junction element.

15. A flexible hose conduit comprising a flexible conduit element (12) as claimed in claim 1 and two hose fittings (22) mounted terminally on the flexible conduit element (12), wherein an electrical resistance measured between the hose fittings is less than 10⁶ ohms, more preferably less than 10⁵ ohms.

16. The flexible conduit element (12) as claimed in claim 2, wherein the Shore A hardness of the first material and/or the Shore A hardness of the second material are less than or equal to 75.

17. The flexible conduit element (12) as claimed in claim 3, wherein the hydrogen transmission rate of the inner layer (14) is lower by a factor of 15 or more than the hydrogen transmission rate of the outer layer (13).

18. The flexible conduit element (12) as claimed in claim 12, wherein the carbon content of the chromium-nickel-molybdenum steel being 0.03% by weight or less and/or the nickel content of the chromium-nickel-molybdenum steel being 12% by weight or more.

19. The flexible conduit element (12) as claimed in claim 18, wherein the chromium-nickel-molybdenum steel is X2CrNiMo17-12-2 as per AISI 316L or X2CrNiMo18-14-3 as per AISI 316L or X6Cr—Ni—Mo—Ti17-12-2 as per AISI 316Ti.

20. The compensator as claimed in claim 14, wherein the compensator fitting has a circumferential groove positioned in an end face for accommodating the connecting portion, wherein the connecting portion (23) has a reinforcing element (17) which is embedded in the conduit element, wherein, after the connection has been produced, an electrical resistance measured between the compensator fittings (18) is less than 10⁹ ohms.
